(19) United States
(12) Patent Application Publication
(10) Pub. No.: US 2008/0302765 A1
(43) Pub. Date: Dec. 11, 2008

(54) Vacuum-Insulated Switching Device

(75) Inventors: Roman Renz, Berlin (DE); Andreas Stelzer, Berlin (DE)

Correspondence Address: LERNER GREENBERG STEMER LLP, P O BOX 2480, HOLLYWOOD, FL, 33022-2480, US

(73) Assignee: SIEMENS AKTIENGESELLSCHAFT, Munich (DE)

(21) Appl. No.: 12/092,130

(22) PCT Filed: Nov. 2, 2005
(86) PCT No.: PCT/DE05/01982

§ 371 Date: Apr. 30, 2008

(51) Int. Cl. H01H 33/66

(52) U.S. Cl. 218/134

(57) ABSTRACT

A vacuum-insulated switching device contains a grounded vacuum vessel, a contact system having a fixed contact and a moving contact, electrical connecting lines coupled to the fixed contact and the moving contact, and vacuum-tight bushings supported by the grounded vacuum vessel, and provide insulation from the grounded vacuum vessel. The vacuum-tight bushings seal the electrical connected lines. An insulating transmission element is provided. A driving apparatus is coupled to the moving contact via the insulating transmission element and in a vacuum-tight manner. Further vacuum-tight bushings are provided. A further vacuum vessel is disposed in the grounded vacuum vessel. The fixed contact and the moving contact are disposed in the further vacuum vessel and pass out of the further vacuum vessel via the further vacuum-tight bushings.

The invention relates to a vacuum-insulated switching device having a grounded vacuum vessel and having a contact system comprising a fixed contact and a moving contact, which are each connected by vacuum-tight bushings, which provide insulation from the housing, to electrical connecting lines, with the moving contact being coupled to a drive apparatus by means of an insulating transmission element and in a vacuum-tight manner.

A switching device such as this is known from EP 09 44 105 B1. The switching device disclosed there has a grounded vacuum vessel in which a fixed contact is connected via a vacuum-tight bushing, which provides insulation from the housing, to an electrical connecting line, and a moving contact is connected by means of an insulating transmission element to a drive apparatus, and via a flexible conductor via a further vacuum bushing, which provides insulation from the housing, to a further connecting line. The fixed contact and the moving contact form a contact system in the switching device in order to make and break a conductive connection between the connecting lines. In order to ensure switching operation and an adequate withstand voltage for the switching device, a pressure of <10⁻⁴ hPa is required within the vacuum vessel. Furthermore, an arrangement such as this requires measures in order to shield the grounded vacuum vessel from the arc which occurs during a switching process.

The object of the present invention is to develop a vacuum-insulated switching device of the type mentioned initially so as to reduce the requirements for the vacuum while still having an adequate withstand voltage and high switching functionality.

According to the invention, this object is achieved in that a further vacuum vessel is arranged in the grounded vacuum vessel, and the fixed contact and the moving contact are arranged in the further vacuum vessel and are passed out of the further vacuum vessel by means of further vacuum-tight bushings.

A switching device such as this advantageously makes it possible to achieve a high switching capacity in the further vacuum vessel because it prevents any interaction between an arc, which occurs between the moving contact and the fixed contact during a switching process, and the grounded vacuum vessel and with other elements arranged in the switching device, such as the connecting lines. Furthermore, a hard vacuum is required only in a small volume of the further vacuum vessel, with a less-hard vacuum being adequate in the grounded vacuum vessel.

In one preferred embodiment, the pressure in the grounded vacuum vessel is less than 10⁻² hPa, and the pressure in the further vacuum vessel is less than 10⁻⁴ hPa. A pressure of <10⁻⁴ hPa in the second vacuum vessel advantageously ensures that the switching device has an adequate switching capacity, with a pressure of <10⁻² hPa in the first vacuum vessel being sufficient to ensure the dielectric insulation of the switching device.

In a further preferred refinement of the invention, a vacuum monitoring device with a pump apparatus is provided on the grounded vacuum vessel. Such a vacuum monitoring device with a pump apparatus advantageously makes it possible to monitor and maintain the pressure required for dielectric insulation in the grounded vacuum vessel.

In one particularly preferred embodiment, the pump apparatus comprises an ion getter pump. An ion getter pump such as this offers a simple and low-cost capability to maintain the pressure in the first vacuum vessel.

In one preferred embodiment, the moving contact is coupled to the drive apparatus by means of a movable drive rod which is sealed by means of a bellows on the grounded vacuum vessel, and a conductive connection is formed between the moving contact and one of the connecting lines by means of a flexible electrical conductor.

An arrangement such as this makes it possible, in a simple manner, to transmit a movement from a drive apparatus to the moving contact in order to close the connection between the fixed contact and the moving contact, and to make an electrical connection by closing the contact system comprising the fixed contact and the moving contact. Further switching functions of the switching device, such as a disconnection function and a grounding function, can be provided in a switching device such as this either outside the grounded vacuum vessel by means of suitable arrangements, or else in the further vacuum vessel if, for example, a vacuum interrupter as described in PCT/DE2005/001613 is advantageously used as the further vacuum vessel.

In another preferred embodiment, the moving contact is coupled to the drive apparatus by means of a transmission element which can pivot and is sealed by means of a bellows on the grounded vacuum vessel, and a conductive connection is formed between the moving contact and one of the connecting lines by means of a flexible electrical conductor.

An arrangement such as this likewise advantageously makes it possible to transmit a movement of a drive apparatus to the moving contact in order to close the contact system comprising the fixed contact and the moving contact.

In one expedient refinement, the transmission element can be pivoted to an intermediate position, which represents a disconnected position, with the flexible electrical conductor being decoupled from the moving contact. In an arrangement such as this, an isolating gap is advantageously formed in the grounded vacuum vessel.

In a further development of the invention, the transmission element can be pivoted to a limit position, in which a conductive connection is formed to the grounded vacuum vessel. This allows the switching device to be grounded in a simple manner.

In a further refinement of the invention, the vacuum-tight bushings are formed from a ceramic material, with joints to the grounded vacuum vessel being metalized. Bushings such as these advantageously allow insulation from the connecting lines, and at the same time the formation of a vacuum-tight connection, for example by means of a soldered joint, to the grounded vacuum vessel.

In a further expedient refinement, the insulating transmission element is formed from a ceramic material. A ceramic material advantageously offers the insulating characteristics for the transmission element.

In one particularly preferred embodiment, the ceramic material is Al₂O₃. Al₂O₃ is particularly advantageous for making vacuum-tight bushings.

In a further expedient refinement of the invention, the vacuum-tight connection of the drive apparatus and transmission element is formed by a bellows. A bellows such as this offers a simple capability to make a connection for transmission of a movement of the drive apparatus to the moving contact piece.

The invention will be explained in more detail in the following text using the drawing and one exemplary embodiment, with reference to the attached figures, in which:

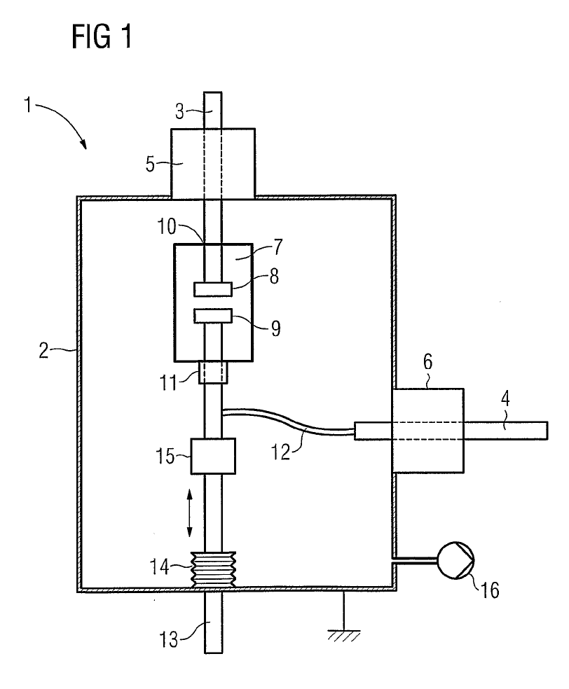

FIG. 1 shows a first exemplary embodiment of a vacuum-insulated switching device according to the invention;

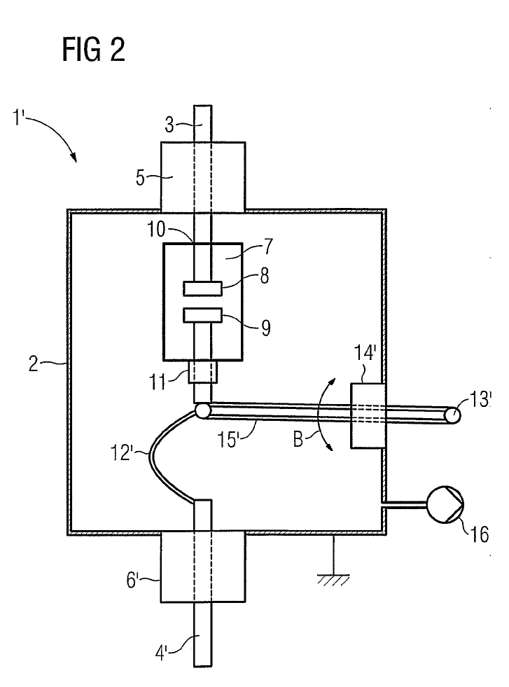

FIG. 2 shows a second exemplary embodiment of a vacuum-insulated switching device according to the invention;

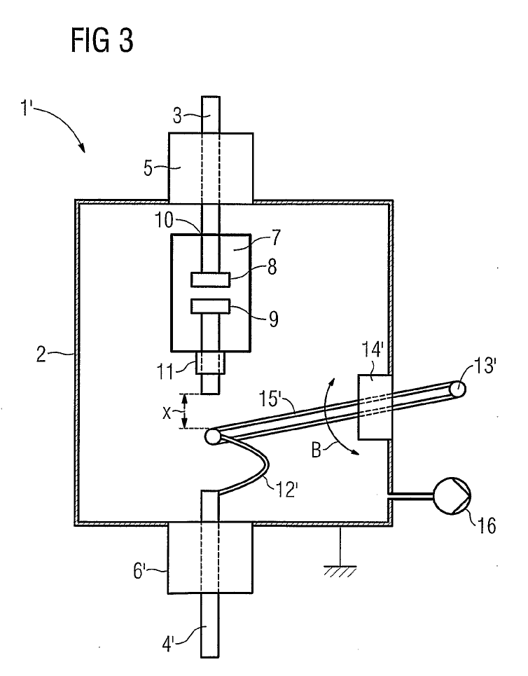

FIG. 3 shows a further exemplary embodiment of a vacuum-insulated switching device according to the invention; and

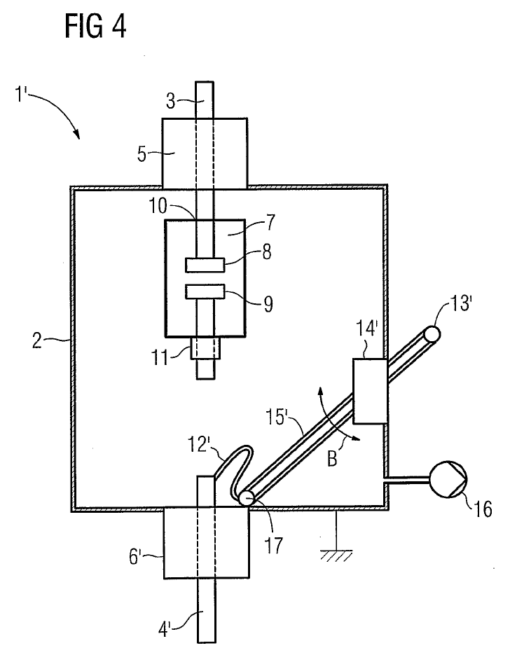

FIG. 4 shows a further exemplary embodiment of a vacuum-insulated switching device according to the invention.

FIG. 1 shows a vacuum-insulated switching device 1 having a grounded vacuum vessel 2 on which connecting lines 3 and 4 are arranged. The connecting lines 3 and 4 are sealed in a vacuum-tight manner by means of respective vacuum-tight bushings 5 and 6 on the grounded vacuum vessel 2. A further vacuum vessel 7 is arranged in the grounded vacuum vessel 2, in which a fixed contact 8 and a moving contact 9 are arranged. The fixed contact 8 is conductively connected by means of a further vacuum-tight bushing 10 to the connecting line 3, and the moving contact 9 is connected via a flexible conductor 12 to the connecting line 4 by means of a likewise vacuum-tight bushing 11 in the form of a bellows 11. A drive movement is transmitted to the moving contact 9 via the insulating transmission element 15, and via a drive rod 13 which is coupled to a drive apparatus (which is not illustrated) and is sealed in a vacuum-tight manner to the first vacuum vessel 2 by means of a bellows 14, so that the moving contact 9 can move between a contact position, in which the fixed contact 8 and the moving contact 9 are connected, and an open position, in which the fixed contact 8 and the moving contact 9 are disconnected from one another. A vacuum monitoring device 16 is arranged on the grounded vacuum vessel 2 in order to monitor and maintain the pressure in the grounded vacuum vessel 2. If the vacuum monitoring device 16 detects a pressure rise in the grounded vacuum vessel which, for example, can result from outgassing of the flexible conductor 12 or the walls of the grounded vacuum vessel 2, then the necessary pressure for dielectric insulation is recreated by means of an ion getter pump, as a pump apparatus, associated with the vacuum monitoring device 16.

In the vacuum-insulated switching device 1, an electrically conductive connection is formed between the connecting lines 3 and 4, wherein the drive rod 13 causes the moving contact 9 (which is firmly connected to it via the transmission element 15) to move in the direction of the fixed contact 8 via the drive apparatus, which is not illustrated. Once the contact position has been reached, in which the fixed contact 8 and the moving contact 9 are connected to one another, then current flows via the connecting line 3, the fixed contact 8, the moving contact 9, the flexible electrical conductor 12 to the connecting line 4. In order to interrupt the electrical connection between the connecting lines 3 and 4, the drive apparatus causes the moving drive rod 13 to move, and the moving contact 9 is disconnected from the fixed contact 8 during this movement. When the moving contact 9 and the fixed contact 8 are disconnected, an arc is struck in the further vacuum vessel 7, and is quenched at the next current zero crossing. The quenching of this arc is ensured by the vacuum formed in the further vacuum vessel 7, so that the vacuum-insulated switching device has an adequate switching capacity. At the same time, the hermetically sealed separation of the further vacuum vessel 7 prevents ions from the arc being able to enter the area of the grounded vacuum vessel 2. The pressure in the grounded vacuum vessel 2 is in a range of ≦10⁻² hPa, and therefore, with appropriate housing dimensions, is in a range below the so-called Paschen minimum, which occurs at about 1 Pa*m, ensuring adequate dielectric insulation in the grounded vacuum vessel 2, with the pressure in the further vacuum vessel 7 being in a range of ≦10⁻⁴ hPa.

In the arrangement shown in FIG. 1, the further functions required for a switching device such as disconnection and grounding of the switching device are provided either by suitable mechanical arrangements outside the grounded vacuum vessel 2 or else in the further vacuum vessel 7, with the further vacuum vessel 7 being in the form of a multi-position vacuum interrupter, for example as described in PCT/DE2005/001613, which is hereby part of the present disclosure.

FIG. 2 shows a further embodiment of a vacuum-insulated switching device 1′ having a grounded vacuum vessel 2 on which connecting lines 3 and 4′ are arranged via the respective vacuum-tight bushings 5 and 6′. The further vacuum vessel 7 is arranged in the grounded vacuum vessel 2 with the fixed contact 8 and the moving contact 9, which are connected via respective further bushings 10 and 11 to the connecting line 3 and via the flexible electrical conductor 12′ to the connecting line 4, respectively. In order to allow the moving contact 9 to move in this embodiment, the moving contact 9 is coupled to an insulating transmission element 15′ in the form of a transmission rod 15′, which is passed out of the grounded vacuum vessel 2 via a vacuum-tight bellows 14′ and is connected to a drive rod 13′, which is mounted such that it can rotate. Rotation of the drive rod 13′ is initiated via a drive apparatus which is not illustrated, and leads to a pivoting movement of the transmission element 15′ in the direction of the arrow B. The vacuum monitoring device 16 is arranged on the grounded vacuum vessel 2.

In this exemplary embodiment, the contact system comprising the fixed contact 8 and the moving contact 9 is closed and opened by pivoting the transmission element 15′, with a connection being made between the connecting lines 3 and 4′ via the contact system comprising the fixed contact 8 and the moving contact 9, as well as the flexible electrical conductor 12′, when the contact system is closed. The further vacuum vessel 7 is used to shield the arc, which occurs during the process of disconnecting the fixed contact 8 and the moving contact 9, from the grounded vacuum vessel 2 and the components arranged in it.

FIG. 3 shows a further refinement of the vacuum-insulated switching device from FIG. 2, with a further contact system being provided as a disconnection contact system for the switching device 1′. In this arrangement, a disconnection process is initiated by the movement of the transmission element 15′ after opening of the contact system comprising the fixed contact 8 and the moving contact 9, during which disconnection process the flexible electrical conductor 12′ is decoupled from the moving contact 9, so that an isolating gap, annotated X, is formed between the moving contact 9 and the flexible electrical conductor 12′.

FIG. 4 shows an embodiment of the vacuum-insulated switching device 1′ in which a grounding function is also provided in the grounded vacuum vessel 2. In this embodiment, after the contact system comprising the fixed contact 8 and the moving contact 9 has been opened, the transmission element 15′ is moved such that the flexible electrical conductor 12′ forms a conductive connection 17 to the grounded vacuum vessel 2. In this position, the switching device is grounded.

### LIST OF REFERENCE SYMBOLS

1, 1′ Vacuum-insulated switching device
2 First vacuum vessel
3 Connecting line
4, 4′ Connecting line
5 Vacuum bushing
6, 6′ Vacuum bushing
7 Second vacuum vessel
8 Fixed contact
9 Moving contact
10, 11 Vacuum bushings
12, 12′ Flexible electrical conductor
13, 13′ Moving drive rod
14, 14′ Bellows
15 Insulating transmission element
15′ Transmission rod
16 Vacuum monitoring device
   17 Grounding

1-12. (canceled)

13: A vacuum-insulated switching device, comprising:
a grounded vacuum vessel;
a contact system having a fixed contact and a moving contact;
electrical connecting lines coupled to said fixed contact and said moving contact;
vacuum-tight bushings supported by said grounded vacuum vessel and providing insulation from said grounded vacuum vessel, said vacuum-tight bushings sealing said electrical connected lines;
an insulating transmission element;
a driving apparatus coupled to said moving contact via said insulating transmission element and in a vacuum-tight manner;
further vacuum-tight bushings; and
a further vacuum vessel disposed in said grounded vacuum vessel, said fixed contact and said moving contact disposed in said further vacuum vessel and pass out of said further vacuum vessel via said further vacuum-tight bushings.

14: The vacuum-insulated switching device according to claim 13, wherein a pressure in said grounded vacuum vessel is less than 10⁻² hPa, and a pressure in said further vacuum vessel is less than 10⁻⁴ hPa.

15: The vacuum-insulated switching device according to claim 13, further comprising a vacuum monitoring device with a pump apparatus disposed on said grounded vacuum vessel.

16: The vacuum-insulated switching device according to claim 15, wherein said pump apparatus contains an ion getter pump.

17: The vacuum-insulated switching device according to claim 13, further comprising:
a movable drive rod, said moving contact is coupled to said drive apparatus by said movable drive rod;
a bellows sealing said movable drive rod on said grounded vacuum vessel; and
a flexible electrical conductor, a conductive connection is formed between said moving contact and one of said connecting lines via said flexible electrical conductor.

18: The vacuum-insulated switching device according to claim 13, further comprising:
a bellows, said moving contact is coupled to said drive apparatus by said insulating transmission element which can pivot and is sealed by said bellows on said grounded vacuum vessel; and
a flexible electrical conductor, a conductive connection is formed between said moving contact and one of said connecting lines by said flexible electrical conductor.

19: The vacuum-insulated switching device according to claim 18, wherein said insulating transmission element can be pivoted to an intermediate position, which represents a disconnected position, with said flexible electrical conductor being decoupled from said moving contact.

20: The vacuum-insulated switching device according to claim 18, wherein said insulating transmission element can be pivoted to a limit position, in which a conductive connection is formed to said grounded vacuum vessel.

21: The vacuum-insulated switching device according to claim 13, wherein said vacuum-tight bushings are formed from a ceramic material, and have joints to said grounded vacuum vessel being metallized.

22: The vacuum-insulated switching device according to claim 13, wherein said insulating transmission element is formed from a ceramic material.

23: The vacuum-insulated switching device according to claim 21, wherein said ceramic material is Al₂O₃.

24: The vacuum-insulated switching device according to claim 22, wherein said ceramic material is Al₂O₃.

25: The vacuum-insulated switching device according to claim 13, further comprising bellows, said vacuum-tight connection of said drive apparatus and said insulating transmission element is formed by said bellows.
